(19) United States
(12) Patent Application Publication
(10) Pub. No.: US 2013/0258945 A1
(43) Pub. Date: Oct. 3, 2013

(54) APPARATUS AND METHOD FOR MANAGING A SESSION ESTABLISHED USING A WIRELESS CHANNEL BETWEEN A BASE STATION AND A MOBILE DEVICE

(71) Applicant: FUJITSU LIMITED, Kawasaki-shi (JP)

(72) Inventors: Tetsuo Tomita, Setagaya (JP); Masanori Hashimoto, Yokohama (JP); Bun Kimura, Yokohama (JP)

(73) Assignee: FUJITSU LIMITED, Kawasaki-shi (JP)

(21) Appl. No.: 13/786,263

(22) Filed: Mar. 5, 2013

(30) Foreign Application Priority Data
Mar. 30, 2012 (JP) 2012-081441

(51) Int. Cl. H04W 76/04

(52) U.S. Cl. CPC H04W 76/045
USPC 370/328

(57) ABSTRACT

A first maintenance signal is exchanged between a server coupled to a base station and a processing unit inside a mobile device, via a wireless channel between the base station and the mobile device, to confirm establishment of a session between the server and the processing unit. The base station sends, to the server, one of control signals according to a connection state of the wireless channel, without sending the received first maintenance signal to the mobile device via the wireless channel, where the control signals includes a second maintenance signal, a session disconnected signal, and a session established signal. The mobile device sends, to the processing unit, one of the control signals according to a connection state of the wireless channel, without sending the received first maintenance signal to the server via the wireless channel.

### CROSS-REFERENCE TO RELATED APPLICATION

This application is based upon and claims the benefit of priority of the prior Japanese Patent Application No. 2012-081441, filed on Mar. 30, 2012, the entire contents of which are incorporated herein by reference.

### FIELD

The embodiments discussed herein relate to apparatus and method for managing a session established using a wireless channel between a base station and a mobile device.

### BACKGROUND

Currently, mobile communication systems such as cellular phone systems and wireless local area networks (LANs) are widely used. For example, 3.5th generation mobile communication systems (for example, a system based on wideband-code division multiple access (W-CDMA)) and 3.9th generation mobile communication systems (for example, a system based on long term evolution (LTE)) are currently domestically used in Japan.

In addition, as a next generation communications technology, for example, there has been proposed a mobile communication system called long term evolution-advanced (LTE-A) that has been developed from LTE by one of standard-setting organizations, the 3rd Generation Partnership Project (3GPP).

In such mobile communication systems, the management of wireless channels is performed by a wireless base station apparatus (hereafter, also referred to as a base station) in accordance with the state of a wireless connection. For example, such a base station is capable of performing processing to connect with and disconnect from a mobile device.

FIG. 13 illustrates a situation in which management of a wireless channel is being performed by a base station 500. A wireless channel is established between the base station 500 and a mobile device 700 via wireless I/F's 510 and 710. For example, the base station 500 is able to control establishment and disconnection of the wireless channel via the wireless I/F 510.

On the other hand, in the mobile device 700, an application service such as browsing of homepages or playing of communication games can be executed in an application processing unit 720. However, the base station 500 does not perform session management when an application service is being executed. Session management for an application service is, for example, performed by a server 600 and the mobile device 700.

Thus, in mobile communication systems, it is sometimes the case that wireless channel management and application service session management are separately performed.

Technologies related to such mobile communication systems include the following. There is a communication apparatus that ensures that communication is efficiently performed without misreading of the timing of congestion in the wireless section due to measurement performed in the TCP level, by changing the window size of the TCP layer that is a higher level than the communication protocol, on the basis of a result of measurement of the state of the wireless section.

In addition, there is also an apparatus that is configured so that, when handover of a mobile terminal is performed, a notification signal is transmuted in the transport layer when the IP layer of the mobile terminal starts and finishes changing the connection point, thereby allowing the apparatus to discriminate between session interruption due to congestion and session interruption due to handover.

Japanese Laid-open Patent Publication No. 2009-218912 and Japanese Laid-open Patent Publication No. 2005-57397 are examples of the related art.

### SUMMARY

According to an aspect of the invention, a system manages a session established using a wireless channel between a base station and a mobile device in a mobile communication system. A first session maintenance signal is exchanged between a server coupled to the base station and an application processing unit inside the mobile device, via the wireless channel, to confirm that a session is established between the server and the application processing unit. The base station sends, to the server, one of control signals according to a connection state of the wireless channel, without sending the received first session maintenance signal to the mobile device via the wireless channel, where the control signals includes a second session maintenance signal responsive to the first session maintenance signal, a session disconnected signal indicating disconnection of the session, and a session established signal indicating restoration of the session. The mobile device sends, to the application processing unit inside the mobile device, one of the control signals according to a connection state of the wireless channel, without sending the received first session maintenance signal to the server via the wireless channel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a mobile communication system, according to a first embodiment;

FIG. 2 is a diagram illustrating a configuration example of a mobile communication system, according to a second embodiment;

FIG. 3 is a diagram illustrating a configuration example of a wireless base station apparatus, according to an embodiment;.

FIG. 4 is a diagram illustrating a configuration example of a mobile device, according to an embodiment;

FIG. 5 is a diagram illustrating an example of an operational sequence performed when quality of an uplink wireless channel is improved, according to an embodiment;

FIG. 6 is a diagram illustrating a configuration example of TCP packet data, according to an embodiment;

FIG. 7 is a diagram illustrating a configuration example of SCTP packet data, according to an embodiment;

FIG. 8 is a diagram illustrating an example of an operational sequence performed when quality of a downlink wireless channel is improved, according to an embodiment;

FIG. 9 is a diagram illustrating an example of an operational sequence performed when quality of an uplink wireless channel has deteriorated, according to an embodiment;

FIG. 10 is a diagram illustrating an example of an operational sequence performed when quality of a downlink wireless channel has deteriorated, according to an embodiment;

FIG. 11 is a diagram illustrating an example of an operational sequence performed when a wireless channel is disconnected, according to an embodiment;

FIG. 12 is a diagram illustrating an example of an operational sequence performed when connection of a wireless channel is restored, according to an embodiment; and

FIG. 13 is a schematic diagram illustrating a situation in which wireless channel management is performed.

### DESCRIPTION OF EMBODIMENTS

For example, in the case where a user performs communication using a mobile device, wireless channel control and service session control are performed at the time when the mobile device is being used by the user. For example, in the case where the user wishes to use a service, the user operates the mobile device and as a result a wireless channel (for example, transmission) and a service session (for example, browsing of the Web) are established. In addition, when the user wishes to finish using the service, the user disconnects the service session and the wireless channel by operating the mobile device. Therefore, in such a case, although wireless channel management and application service session management are independent of each other, the wireless channel management and the application service session management are not separately performed.

However, sometimes various other types of communication are performed in addition to those performed in response to an operation performed by a user. In such a case, wireless channel management and application session management are controlled separately and the connection state of a service session fails to move on with the connection state of the wireless channel. As a result, unnecessary traffic and unnecessary use of wireless resources may sometimes occur. For example, the following situations may occur.

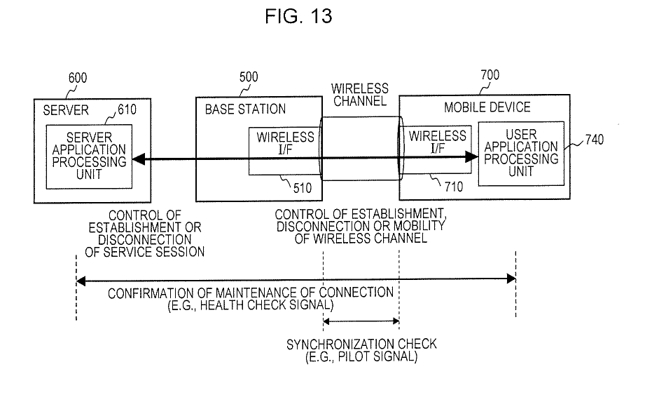

1) For example, in FIG. 13, each of the application processing units 610 and 740 may be configured to wait for a response from the other party, such as confirmation of delivery or a health check, before disconnecting the session.

Therefore, in a case where it has become no longer possible for wireless communication to be performed through the wireless channel, the application may disconnect the session by detecting that arrival of response to a health check has stopped, without detecting interruption of wireless communication directly from the wireless channel.

Consequently, a time lag occurs between interruption of the wireless channel and disconnection of the service session, and, for example, the server 600 continues to transmit data during the time lag even though the mobile device 700 is not be able to receive the data. Therefore, the data as unnecessary traffic may be transmitted by the server 600 during the time lag.

2) For example, as illustrated in FIG. 13, sometimes a synchronicity check is performed between the base station 500 and the mobile device 700 through the wireless channel. The synchronicity check may be, for example, performed by using a pilot signal so as to confirm establishment of a wireless connection.

On the other hand, whether or not a service session is being maintained is confirmed by performing, for example, the above-mentioned health check operation between the service application processing unit 610 and the user application processing unit 740. In a health check operation, for example, a health check signal, such as a KEEPALIVE signal in the transmission control protocol (TCP), is used.

Focusing on the wireless section, confirmation of connection of the wireless channel is performed using a pilot signal or the like, whereas connection of a service session is confirmed using a health check signal or the like. Therefore, in the wireless section, two signals are transmitted and received for confirmation of connection, generating unnecessary traffic.

In this case, since base station 500 transmits or receives a health check signal that has a short packet length compared with other types of signals, signals are transmitted or received using only part of the wireless resources of the wireless frame. Therefore, there is a lot of empty space left within the wireless frame compared to the case of other types of signals. That is, when the base station 500 transmits a health check signal, the usage efficiency of wireless resources may become worse than in the case where other types of signals are transmitted.

In addition, since the base station 500 periodically transmits a health check signal, the power consumption of the mobile device 700 may be increased compared with the case where a health check signal is not received.

Consideration of the above-described situations 1) and 2) is not given in the above-described technology in which the window size is changed and in the technology in which the IP layer transmits a notification signal notifying the transport layer of the changing or ending of a connection point.

That is, the above-described technology in which window size is changed on the basis of radio quality does not take account of TCP level data and is unable to deal with the unnecessary traffic mentioned above.

Further, in the technology in which the IP layer transmits a notification signal notifying the transport layer of changing or ending of a connection point, notification is only made of changing of a connection point, and no consideration is given for TCP level data. Therefore, the above-described technology is unable to deal with the unnecessary traffic mentioned above.

Hereafter, embodiments will be described.

### First Embodiment

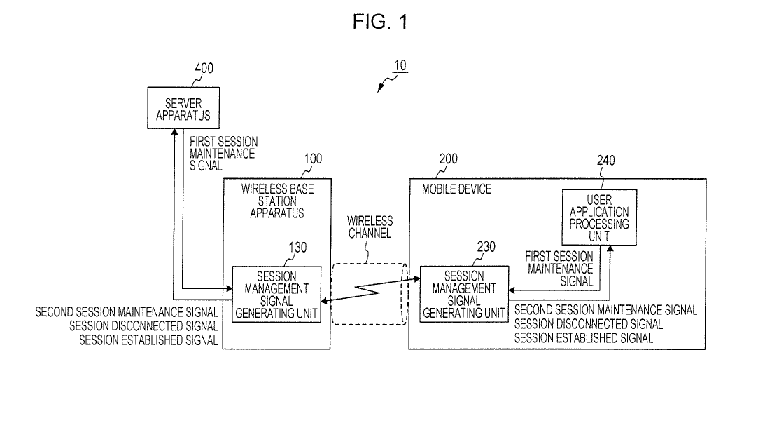

First, a first embodiment will be described. FIG. 1 illustrates a configuration example of a mobile communication system 10 of the first embodiment. The mobile communication system 10 includes a wireless base station apparatus 100, a mobile device 200 and a server apparatus 400.

In the mobile communication system 10, session maintenance signals for confirming establishment of a session between the server apparatus 400 and the mobile device 200 are transmitted and received between the server apparatus 400 and the mobile device 200.

For example, the server apparatus 400 and the mobile device 200 can periodically transmit a session maintenance signal. The mobile device 200 receives a session maintenance signal transmitted from the server apparatus 400 and can thereby confirm that a session is established between itself and the server apparatus 400. In addition, the server apparatus 400 receives a session maintenance signal transmitted from the mobile device 200 and thereby confirms that a session is established between the server apparatus 400 and the mobile device 200. Alternatively, the server apparatus 400 is configured to receive a response to a session maintenance signal transmitted to the mobile device 200 by the server apparatus 400 and thereby confirms that a session is established between itself and the mobile device 200.

The wireless base station apparatus 100 is connected to the server apparatus 400 and performs wireless communication with the mobile device 200. The wireless base station apparatus 100 includes a session management signal generating unit 130.

The session management signal generating unit 130, for example, depending on the connection state of a wireless channel between the wireless base station apparatus 100 and the mobile device 200, does not transmit through the wireless channel a first session maintenance signal transmitted from the server apparatus 400, but instead transmits a second session maintenance signal to the server apparatus 400 in response to the first session maintenance signal transmitted thereto by the server apparatus 400. In addition, the session management signal generating unit 130, for example, transmits to the server apparatus 400 a session disconnected signal indicating that a session has been disconnected or a session established signal indicating that a session has been restored in accordance with the connection state of a wireless channel between the base station apparatus 100 and the mobile device 200.

The mobile device 200 includes a session management signal generating unit 230. The session management signal generating unit 230, for example, depending on the connection state of a wireless channel between the base station apparatus 100 and the mobile device 200, does not transmit through the wireless channel a first session maintenance signal transmitted from inside the mobile device 200, but rather transmits inside the mobile device 200 a second session maintenance signal in response to the first maintenance signal. In addition, the session management signal generating unit 230, for example, transmits a session disconnected signal or a session established signal inside the mobile device 200 in accordance with the connection state of a wireless channel between the wireless base station apparatus 100 and the mobile device 200.

For example, a user application processing unit 240 is provided inside the mobile device 200 and when a session maintenance signal is transmitted by the user application processing unit 240 to the session management signal generating unit 230, the session management signal generating unit 230 transmits a response signal to the user application processing unit 240.

Thus, depending on the connection state of the wireless channel, the wireless base station apparatus 100 and the mobile device 200 are capable of operating so as not to transmit a first session maintenance signal through the wireless channel. For example, in the case where the connection state of the wireless channel is better than a threshold, the wireless base station apparatus 100 and the mobile device 200 may operate so that a first session maintenance signal is not transmitted through the wireless channel.

For example, in the case where the connection state of the wireless channel is better than a threshold, it is expected that there will be a certain level of assurance that the data will reach the transmission destination when the wireless base station apparatus 100 or the mobile device 200 transmits data. Under such a condition, transmitting of a first session maintenance signal through the wireless channel by the wireless base station apparatus 100 or the mobile device 200 may result in unnecessary traffic.

Therefore, in such a case, the wireless base station apparatus 100 and the mobile device 200 do not transmit a first session maintenance signal and as a result the mobile communication system 10 is able to reduce the occurrence of unnecessary traffic.

In addition, since a first session maintenance signal is not transmitted through the wireless channel, for example, the wireless base station apparatus 100 may utilize the corresponding amount of wireless resources for transmission of other data or the like. Therefore, the mobile communication system 10 is able to make more effective practical use of wireless resources thereof.

In addition, since the first session maintenance signal is not transmitted through the wireless channel, the mobile device 200 no longer receives the first session maintenance signal, which would have otherwise for example been received periodically, and therefore the mobile communication system 10 is able to achieve a reduction in the power consumption of the mobile device 200 by the corresponding amount.

In addition, in accordance with the connection state of the wireless channel, the wireless base station apparatus 100 is able to transmit a session disconnected signal or a session established signal to the server apparatus 400, and the mobile device 200 is able to transmit a session disconnected signal or a session established signal within the mobile device 200.

For example, the server apparatus 400 is able to grasp the fact that the connection state of the wireless channel has become a disconnected state as a result of receiving a session disconnected signal. The server apparatus 400 may be configured to operate such that data is not transmitted to the mobile device 200 when a session disconnected signal has been received. This allows the mobile communication system 10 to reduce the occurrence of unnecessary traffic.

In addition, the server apparatus 400, for example, is able to grasp the fact that the connection state of the wireless channel has been restored and able to speedily start transmission of data to the mobile device 200 upon receiving a session established signal.

Hereinafter, for ease of explanation, “server apparatus” and “wireless base station apparatus” will be also expressed as “server” and “base station”, respectively.

### Second Embodiment

Example of Overall Configuration

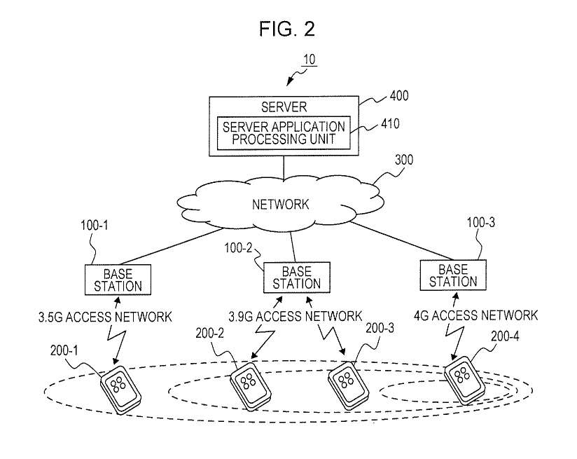

Next, a second embodiment will be described. FIG. 2 illustrates a configuration example of a mobile communication system 10.

The mobile communication system 10 includes wireless base station apparatuses (hereafter, also referred to as “base stations”) 100-1 to 100-3, mobile devices 200-1 to 200-4, a network 300 and a server apparatus (hereafter, also referred to as “server”) 400.

In the example illustrated in FIG. 2, the base station 100-1 and the mobile device 200-1 constitute a 3.5G access network and perform wireless communication using, for example, the W-CDMA scheme. In addition, the base station 100-2 and the mobile devices 200-2 and 200-3 constitute a 3.9G access network and perform wireless communication using, for example, the LTE scheme. In addition, the base station 100-3 and the mobile device 200-4 constitute a 4G access network and perform wireless communication, for example, as a fourth generation mobile communication system.

Although one example of a way in which the base stations 100-1 to 100-3 and the mobile devices 200-1 to 200-4 are connected to one another is illustrated in FIG. 2, a plurality of kinds of wireless communications may be performed with any one base station, and a plurality of kinds of wireless communication may be performed by any one of the mobile devices 200-1 to 200-4. This embodiment may be implemented with any of the base stations 100-1 to 100-3, and may be implemented with any of the mobile devices 200-1 to 200-4. There is no limit on the number of base stations 100-1 to 100-3 and mobile devices 200-1 to 200-4 in the mobile communication system 10.

In the example illustrated in FIG. 2, for example, the base stations 100-1 to 100-3 are each connected to the server 400 through the network 300. For example, the network 300 is the Internet, and data is transmitted and received between the base stations 100-1 to 100-3 and the server 400 using, for example, an IP protocol.

The mobile devices 200-1 to 200-4 is able to perform wireless communication with the respective base stations 100-1 to 100-3 within the cell ranges of the base stations 100-1 to 100-3. The mobile devices 200-1 to 200-4 are connected to the server 400 via the respective base stations 100-1 to 100-3 and, as a result, are provided with a variety of application services such as browsing of home pages and communication games.

The base stations 100-1 to 100-3 are configured to convert data transmitted from the server 400 into radio signals and wirelessly transmit the radio signals to the mobile devices 200-1 to 200-4. In addition, the base stations 100-1 to 100-3 are configured to receive radio signals transmitted from the mobile devices 200-1 to 200-4, extract data from the radio signals, and transmit the data to the server 400.

Configuration Example of Wireless Base Station Apparatus 100

Next, a configuration example of the base stations 100-1 to 100-3 will be described. Here, since the base stations 100-1 to 100-3 transmit and receive radio signals using their respective communication schemes, their configurations may be different from one another, but, for ease of description, in this embodiment, description will be made assuming that the base stations 100-1 to 100-3 are configured to perform any communication scheme. Therefore, the configuration examples of the base stations 100-1 to 100-3 in this embodiment are, for example, the same configuration and will be described as the base station 100 unless otherwise noted. Similarly, the mobile devices 200-1 to 200-4 which will be described below are described as the mobile device 200 unless otherwise noted.

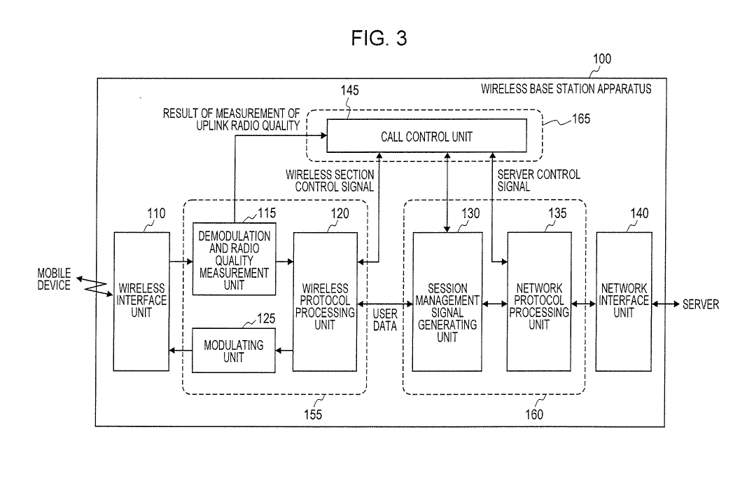

FIG. 3 illustrates a configuration example of the base station 100.

The base station 100 includes a wireless interface unit 110, a demodulation and radio quality measurement unit 115, a wireless protocol processing unit 120, a modulating unit 125, a session management signal generating unit 130, a network protocol processing unit 135, a network interface unit 140, and a call control unit 145.

The base station 100 may, for example, include a digital signal processor (DSP) 155, a network processor 160, a central processing unit (CPU) 165, the wireless interface unit 110, and the network interface unit 140.

In this case, the DSP 155, for example, is formed of the demodulation and radio quality measurement unit 115, the wireless protocol processing unit 120, and the modulating unit 125. In addition, the network processor 160, for example, is formed of the session management signal generating unit 130, and the network protocol processing unit 135. In addition, the CPU 165, for example, is formed of the call control unit 145.

The wireless interface unit 110, for example, is an antenna. The wireless interface unit 110 receives a radio signal transmitted from the mobile device 200 and outputs the radio signal to the demodulation and radio quality measurement unit 115. The wireless interface unit 110 also, for example, transmits a radio signal output from the modulating unit 125 to the mobile device 200.

The demodulation and radio quality measurement unit 115, for example, subjects a radio signal to frequency conversion processing, demodulation processing, and error correction decoding processing, converts the radio signal into predetermined packet data (baseband signal) and outputs the packet data to the wireless protocol processing unit 120. Accordingly, the demodulation and radio quality measurement unit 115 may be configured to include, for example, a frequency conversion circuit, a demodulation circuit, and an error correction decoding circuit so as to perform the frequency conversion processing and demodulation processing.

In addition, the demodulation and radio quality measurement unit 115, for example, measures the radio quality of the wireless section between the base station 100 and the mobile device 200 on the basis of a radio signal transmitted from the mobile device 200. In this case, the radio quality is uplink radio quality since the radio quality is measured on the basis of a radio signal transmitted from the mobile device 200. The demodulation and radio quality measurement unit 115 outputs the result of measurement of the uplink radio quality to the call control unit 145. The demodulation and radio quality measurement unit 115 may measure radio quality, for example, using a ratio of the portion of a signal that is meaningful after being demodulated and decoded, to the portion of the signal that is not meaningful despite being demodulated and decoded (for example, signal to interference plus noise ratio (SINR)).

The wireless protocol processing unit 120, for example, converts predetermined packet data that is based on a wireless communication protocol and output from the demodulation and radio quality measurement unit 115, into TCP packet data based on the TCP protocol. The wireless protocol processing unit 120 outputs the TCP packet data obtained through the conversion (for example, user data) to the session management signal generating unit 130. In addition, for example, in the case where the predetermined packet data includes a control signal, the wireless protocol processing unit 120 extracts the control signal and outputs the extracted control signal to the call control unit 145.

In addition, the wireless protocol processing unit 120, for example, acquires TCP packet data (for example, user data) output from the session management signal generating unit 130 and a control signal output from the call control unit 145 and converts the acquired data and signal into predetermined packet data of the wireless communication protocol. The wireless protocol processing unit 120 outputs the converted packet data to the modulating unit 125.

The modulating unit 125, for example, converts the packet data output from the wireless protocol processing unit 120 into a radio signal by subjecting the packet data to error correction encoding processing, modulation processing, and frequency conversion processing. The modulating unit 125 outputs the converted radio signal (for example, downlink radio signal) to the wireless interface unit 110.

The session management signal generating unit 130, for example, discriminates whether the user data output from the network protocol processing unit 135 and the wireless protocol processing unit 120 is a session maintenance signal or service data.

In addition, the session management signal generating unit 130 generates a response signal (for example, a second session maintenance signal) as a response to a session maintenance signal (for example, a first session maintenance signal) transmitted from the server 400, a session disconnected signal, or a session established signal, in response to an instruction from the call control unit 145. The session management signal generating unit 130 transmits the generated response signal, the session disconnected signal, or the session established signal to the server 400 via the network protocol processing unit 135.

Even though the session management signal generating unit 130 acquires a session maintenance signal from the network protocol processing unit 135, the session management signal generating unit 130 does not output this signal to the wireless protocol processing unit 120. In this case, the session management signal generating unit 130 transmits a response signal as a response to the acquired session maintenance signal to the server 400 via the network protocol processing unit 135.

The session maintenance signal, the response signal which is a response to the session maintenance signal, the session disconnected signal, and the session established signal will be described in detail below.

In addition, for example, when the user data is service data, the session management signal generating unit 130 passes the user data on and outputs the user data to both the wireless protocol processing unit 120 and the network protocol processing unit 135.

Here, “service data” is data that is used when a service, such as web browsing or an audio service, is provided to a user, and includes, for example, character data, image data, and audio data. The service data is subjected to processing in the user application processing unit 240 of the mobile device 200 and a server application processing unit 410 of the server 400, and is exchanged between these two units.

The network protocol processing unit 135, for example, converts data, such as user data, a response signal, a session disconnected signal, and a session established signal, output from the session management signal generating unit 130 into packet data in accordance with the network protocol. For example, the network protocol processing unit 135 is able to convert TCP packet format data into IP data by inserting TCP packet data into the IP data field of the TCP packet format data, and adding an IP header.

In addition, the network protocol processing unit 135, for example, acquires a server control signal output from the call control unit 145 and converts the acquired signal into network protocol packet data. The network protocol processing unit 135 outputs the converted packet data to the network interface unit 140.

In addition, the network protocol processing unit 135, for example, converts network protocol packet data output from the network interface unit 140 into a format that is processable within the base station 100 and outputs the converted packet data to the session management signal generating unit 130. For example, the network protocol processing unit 135 may be configured to extract TCP packet data included in the IP data field of the IP data output from the network interface unit 140 and output the extracted TCP packet data to the session management signal generating unit 130.

The network interface unit 140 is, for example, an adapter that is connected to the network 300. The network interface unit 140 receives data transmitted from the server 400 and outputs the received data to the network protocol processing unit 135. In addition, the network interface unit 140 transmits data output from the network protocol processing unit 135 to the server 400 via the network 300.

The call control unit 145, for example, acquires a result of measurement of uplink radio quality output from the demodulation and radio quality measurement unit 115 and issues various instructions to the session management signal generating unit 130 on the basis of the acquired measurement result of the uplink radio quality.

For example, the call control unit 145 issues an instruction for generation and transmission of a response signal as a response to a session maintenance signal, an instruction for stopping of generation and transmission of a response signal, an instruction for generation and transmission of a session disconnected signal, or an instruction for generation and transmission of a session established signal. On the basis of the issued instructions, for example, the session management signal generating unit 130 is able to generate a session maintenance signal, a session disconnected signal or a session established signal and transmit the generated signal to the server 400 that handles the user data.

In addition, the call control unit 145, for example, generates a wireless section control signal and transmits the generated control signal to the mobile device 200 via the wireless protocol processing unit 120. The call control unit 145, for example, receives, from the mobile device 200, a control signal expressing a response to the control signal. An example of a wireless section control signal is a control signal instructing handover of the mobile device 200 and the call control unit 145 is able to acquire a control signal indicating that handover has been performed from the mobile device 200, as a response to the wireless section control signal.

In addition, the call control unit 145, for example, generates a server control signal, transmits the server control signal to the server 400 via the network protocol processing unit 135, and receives, from the server 400, a control signal expressing a response to the control signal. An example of a server control signal is a control signal instructing call connection with the mobile device 200 and the call control unit 145 is able to receive a control signal indicating that call connection has been performed, as a response to the server control signal.

Configuration Example of Mobile Device 200

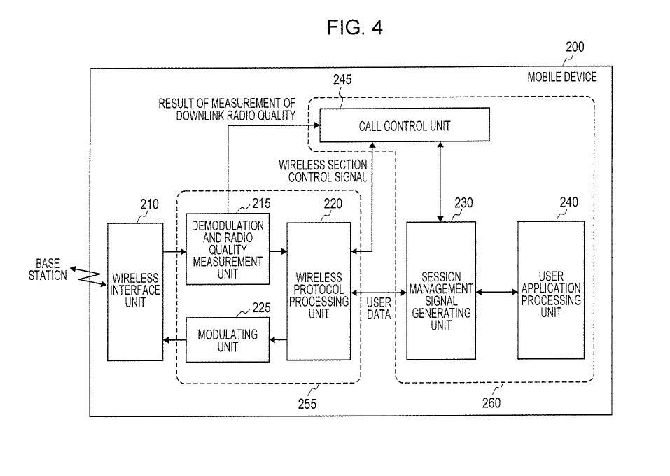

Next, a configuration example of the mobile device 200 will be described. FIG. 4 illustrates a configuration example of the mobile device 200.

The mobile device 200 includes a wireless interface unit 210, a demodulation and radio quality measurement unit 215, a wireless protocol processing unit 220, a modulating unit 225, a session management signal generating unit 230, a user application processing unit 240, and a call control unit 245.

The mobile device 200 may be configured to include a DSP 255, a CPU 266, and the wireless interface unit 210.

In this case, the DSP 255, for example, is formed of the demodulation and radio quality measurement unit 215, the wireless protocol processing unit 220, and the modulating unit 225. Further, the CPU 260, for example, is formed of the session management signal generating unit 230, the user application processing unit 240, and the call control unit 245.

The wireless interface unit 210 is, for example, an antenna. The wireless interface unit 210, for example, receives a radio signal transmitted from the base station 100, outputs the radio signal to the demodulation and radio quality measurement unit 215. The wireless interface unit 210 also, for example, transmits a radio signal output from the modulating unit 225 to the base station 100.

The demodulation and radio quality measurement unit 215, for example, subjects the radio signal to frequency conversion processing, demodulation processing, and error correction decoding processing, converts the radio signal into predetermined packet data (baseband signal), and outputs the converted data to the wireless protocol processing unit 220. The demodulation and radio quality measurement unit 215 may be configured to include, for example, a frequency conversion circuit, a demodulation circuit, and an error correction decoding circuit so as to perform the frequency conversion processing and demodulation processing.

In addition, the demodulation and radio quality measurement unit 215, for example, measures the radio quality of the wireless section between the mobile device 200 and the base station 100 (downlink radio quality) on the basis of a radio signal transmitted from the base station 100. The demodulation and radio quality measurement unit 215 outputs the result of measurement of the downlink radio quality to the call control unit 245. The demodulation and radio quality measurement unit 215, similarly to the demodulation and radio quality measurement unit 115 of the base station 100, may be configured to measure radio quality, for example, using a ratio of the portion of a signal that is meaningful after being demodulated and decoded, to the portion of the signal that is not meaningful despite being demodulated and decoded.

The wireless protocol processing unit 220, for example, converts predetermined packet data based on the wireless communication protocol output from the demodulation and radio quality measurement unit 215, into packet data of a protocol of a higher level (for example, TCP protocol) than the wireless communication protocol. The wireless protocol processing unit 220 outputs the converted packet data (for example, user data) to the session management signal generating unit 230. In addition, for example, in the case where the predetermined packet data includes a control signal, the wireless protocol processing unit 220 extracts the control signal and outputs the extracted control signal to the call control unit 245.

In addition, the wireless protocol processing unit 220 receives packet data (for example user data) output from the session management signal generating unit 230 and a control signal output from the call control unit 245, and converts the received data and signal into predetermined packet data of the wireless communication protocol. The wireless protocol processing unit 220 outputs the converted packet data to the modulating unit 225.

The modulating unit 225, for example, subjects packet data output from the wireless protocol processing unit 220 to error correction encoding processing, modulation processing, and frequency conversion processing, converts the packet data into a radio signal, and then outputs the converted radio signal (for example, uplink radio signal) to the wireless interface unit 210.

The session management signal generating unit 230, for example, determines whether the user data output from the user application processing unit 240 and the wireless protocol processing unit 220 is a session maintenance signal or service data.

In addition, in response to an instruction from the call control unit 245, the session management signal generating unit 230, for example, generates a response signal (for example, second session maintenance signal) as a response to a session maintenance signal (for example, first session maintenance signal) output from the user application processing unit 240, a session disconnected signal, or a session established signal, and transmits the generated signal to the user application processing unit 240.

For example, even though the session management signal generating unit 230 receives a session maintenance signal from the user application processing unit 240, the session management signal generating unit 230 does not output this signal to the wireless protocol processing unit 220. The session management signal generating unit 230, for example, generates a response signal as a response to the session maintenance signal from the user application processing unit 240 and transmits the generated response signal to the user application processing unit 240.

When the user data is service data, the session management signal generating unit 230 passes the user data on and outputs the user data to the wireless protocol processing unit 220 or the user application processing unit 240.

The call control unit 245, for example, receives a result of measurement of the downlink radio quality output from the demodulation and radio quality measurement unit 215 and issues various instructions to the session management signal generating unit 230 on the basis of the result of the measurement of downlink radio quality.

For example, the call control unit 245 issues an instruction for generation and transmission of a response signal as a response to a session maintenance signal, an instruction for stopping of generation and transmission of a response signal, an instruction for generation and transmission of a session disconnected signal, or an instruction for generation and transmission of a session established signal. On the basis of these instructions, the session management signal generating unit 230, for example, transmits a response signal responsive to the session maintenance signal, a session disconnected signal, or a session established signal to the user application processing unit 240.

In addition, the call control unit 245, for example, receives a wireless section control signal transmitted from the base station 100 via the wireless protocol processing unit 220, generates a control signal expressing a response to the received wireless section control signal, and transmits the generated control signal to the base station 100 via the wireless protocol processing unit 220.

Example of Operation

Next, an example of operation of the mobile communication system 10 will be described. An example of operation will be described for the following four cases: connection state of wireless channel is good; connection state of wireless channel has deteriorated; connection of wireless channel is disconnected; and connection of wireless channel is restored.

1. Connection State of Wireless Channel is Good

First, an example of operation in the case where the connection state of the wireless channel is good will be described.

In this example of operation, the connection state, for example, corresponds to the radio quality of the wireless channel. For example, a case where the radio quality is high is a case where the connection state is better than a state indicated by a threshold. In addition, for example, a case where the radio quality has deteriorated is a case where the connection state has become worse than a state indicated by the threshold. The call control unit 145 of the base station 100 and the call control unit 245 of the mobile device 200 may be configured to discriminate whether the connection state of the wireless channel is better or worse than a state indicated by the threshold, on the basis of, for example, the radio quality.

There are two wireless channels, namely, an uplink direction (for example, direction from the mobile device 200 toward the base station 100) wireless channel and a downlink direction (for example, direction from the base station 100 toward the mobile device 200) wireless channel.

Hereafter, two examples of operation will be described, that is, for a case in which the operation is performed at a time when the quality of the uplink channel is improved (that is, the connection state becomes better than a state indicated by a threshold) and a case in which the operation is performed at a time when the quality of the downlink channel is improved.

1.1 Case in which Operation is Performed at a Time when Quality of Uplink Wireless Channel is High

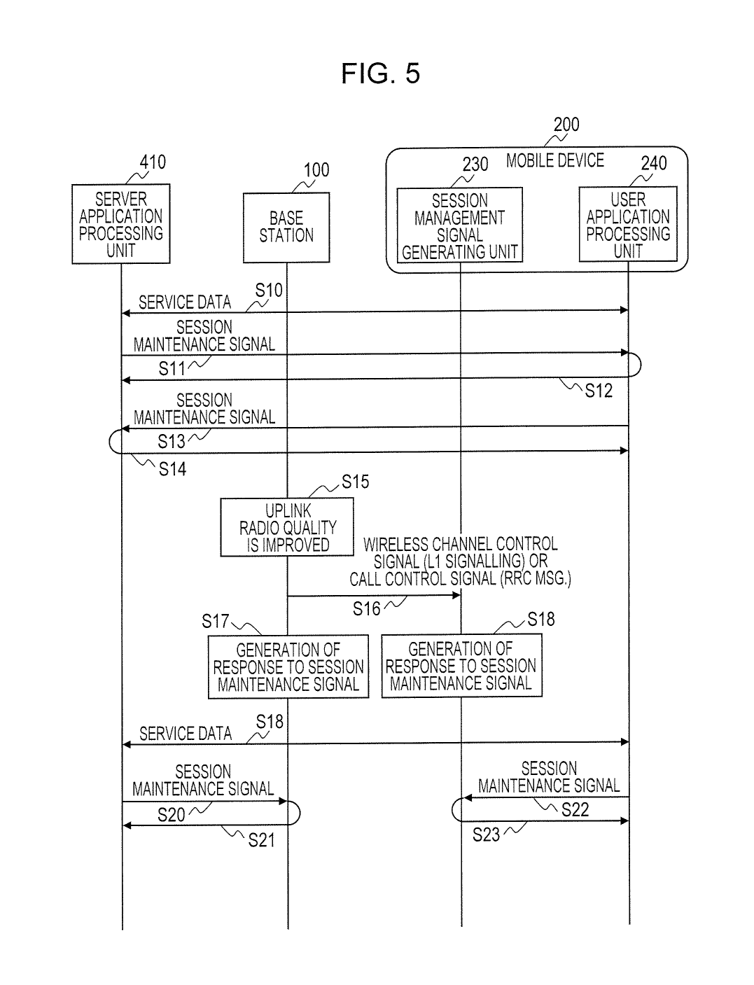

FIG. 5 is a sequence diagram for the case in which operation is performed at a time when the quality of the uplink wireless channel is improved.

The server application processing unit 410 of the server 400 and the user application processing unit 240 of the mobile device 200 exchange service data with each other (S10).

The server application processing unit 410 generates a session maintenance signal and transmits the session maintenance signal to the user application processing unit 240 (S11). The session maintenance signal, for example, is a signal for notifying and confirming that a session is in effect. For example, in the TCP protocol, a signal called a KEEPALIVE signal (sometimes also called HEALTHCHECK signal) serves as the session maintenance signal. In addition, for example, in the stream control transmission protocol (SCTP), a signal called a HEARTBEAT signal serves as the session maintenance signal.

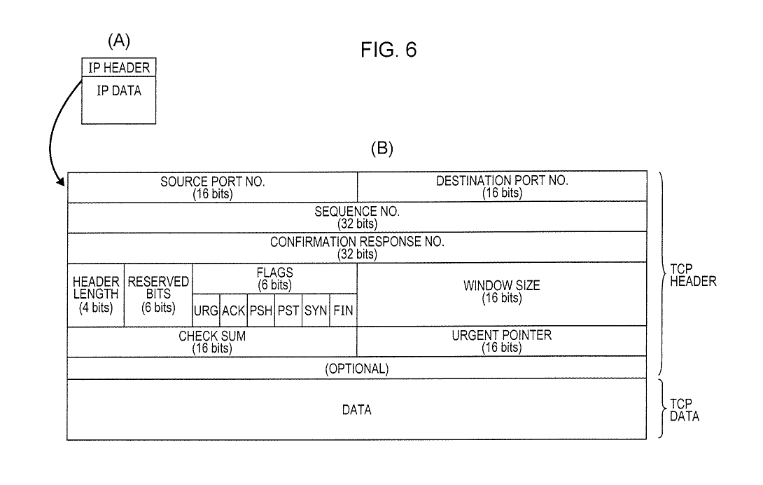

FIG. 6 illustrates a configuration example of TCP packet data. TCP packet data, for example, includes a TCP header field and a TCP data field. A KEEPALIVE signal, for example, is TCP packet data that contains data only in the TCP header field and contains no data inserted into the TCP data field (or there is no TCP data field). A KEEPALIVE signal is sometimes also called null TCP packet data.

For example, the server application processing unit 410 generates and periodically transmits a KEEPALIVE signal (S11), and the user application processing unit 240 receives the KEEPALIVE signal, so that the mobile device 200 confirms that a session between the mobile device 200 and the server 400 is being maintained. When the user application processing unit 240 fails to receive the KEEPALIVE signal, the mobile device 200 determines that the session with the server 400 is not being maintained.

On the other hand, the user application processing unit 240 also generates and periodically transmits a KEEPALIVE signal (S12), and the server application processing unit 410 receives this KEEPALIVE signal, so that the server 400 confirms that the session with the mobile device 200 is being maintained. When the server application processing unit 410 fails to receive the KEEPALIVE signal, the server 400 determines that the session with the mobile device 200 is not being maintained.

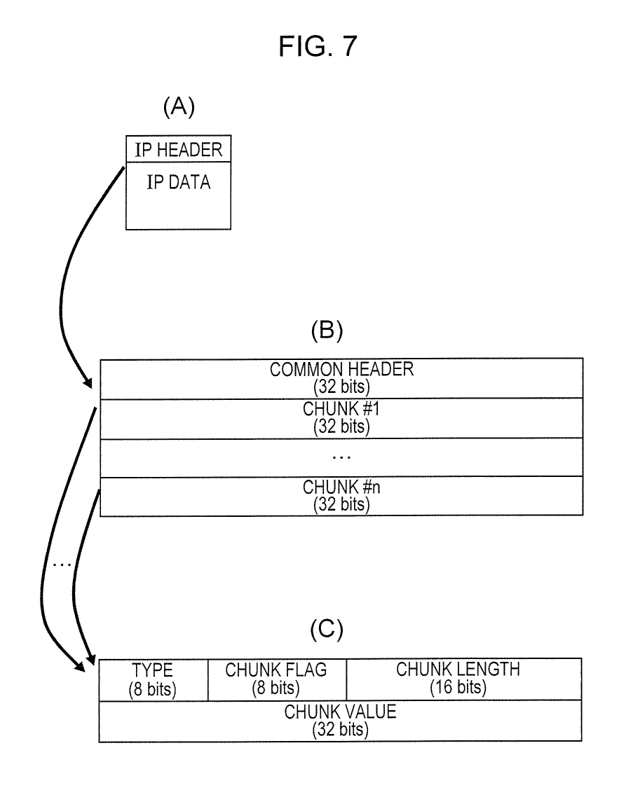

FIG. 7 illustrates a configuration example of SCTP packet data. A generic chunk header included in each chunk of SCTP packet data (for example, FIG. (B)) includes a type field (for example, (C)). For example, when “4” is inserted into this type field, this chunk indicates that the packet data is a HEARTBEAT signal.

For example, when the server application processing unit 410 generates and transmits a HEARTBEAT signal (S11) and the user application processing unit 240 receives this HEARTBEAT signal, the user application processing unit 240 generates a HEARTBEAT ACKNOWLEDGMENT (ACK) signal to acknowledge the HEARTBEAT signal and transmits the ACK signal to the server 400 (S12). As a result of the server application processing unit 410 receiving this ACK signal, the server 400 confirms acknowledgment and maintenance of the session with the mobile device 200.

In addition, the user application processing unit 240 also generates and transmits a HEARTBEAT signal (S13) and receives an ACK signal as an acknowledgment of this signal from the server 400 (S14), so that the mobile device 200 confirms that the session with the server 400 is being maintained.

For example, the user application processing unit 240 and the server application processing unit 410 generate an ACK signal as an acknowledgment of the HEARTBEAT signal by inserting “5” into the type field of a generic chunk header.

Thus, a different session maintenance signal is used depending on the protocol that is adopted, but, as described above, both types of signals function as a signal for confirming that a session is in effect.

In the case, as described above, the session management signal generating unit 130 of the base station 100 and the session management signal generating unit 230 of the mobile device 200 determine whether user data is a session maintenance signal or service data. For example, the determination mentioned above may be performed in the following way.

That is, in the case of a TCP KEEPALIVE signal, for example, since only the TCP header is included in the TCP packet data, the session management signal generating units 130 and 230 may determine whether the TCP packet data is a KEEPALIVE signal or not, from the size of the TCP packet data.

In the case of an SCTP HEARTBEAT signal, for example, since the value included in the type field of the generic chunk header is “4”, the session management signal generating units 130 and 230 may determine whether the signal is a HEARTBEAT signal, from the value included in the type field of the generic chunk header.

Returning back to FIG. 5, the base station 100 periodically measures the radio quality of an uplink signal from the mobile device 200. For example, the demodulation and radio quality measurement unit 115 measures the radio quality of the uplink signal and notifies the call control unit 145 of the result of the measurement.

Upon detecting that the uplink radio quality is improved (S15), the base station 100 instructs the session management signal generating unit 130 to begin generation and transmission of a response signal as a response to the session maintenance signal.

For example, regarding the uplink radio quality (result of measurement of uplink radio quality), in the case where the call control unit 145 detects that a state equal to or better than that indicated by the threshold has continued for a certain period of the time, a high uplink radio quality is determined to be improved.

In addition, the call control unit 145, for example, may also instruct starting of generation and transmission of a response signal through a wired channel toward the server 400 to which the user data of the mobile device 200 is to be transmitted. For example, in the case of a plurality of mobile devices 200 communicating with the base station 100, the call control unit 145 is able to manage the sessions between the server 400 and each of the mobile devices 200 communicating with the server 400 and to issue the instruction using the wired channel during each session.

The base station 100 instructs the mobile device 200 to start generation and transmission of a response signal as a response to a session maintenance signal (S16). Regarding this instruction, for example, the call control unit 145 may instruct the mobile device 200 by using a call control signal included in a radio resource control (RRC) message exchanged between the call control unit 145 of the base station 100 and the call control unit 245 of the mobile device 200. Alternatively, the base station 100 may instead instruct the mobile device 200 by using a wireless channel control signal based on an L1 signal exchanged between the wireless protocol processing unit 120 of the base station 100 and the wireless protocol processing unit 220 of the mobile device 200. In the latter case, the call control unit 145 able to instruct the mobile device 200 to start generation and transmission of a response signal as a response to the session maintenance signal, by issuing an instruction to the wireless protocol processing unit 120.

Next, the base station 100 generates a response signal as a response to the session maintenance signal transmitted from the server application processing unit 410 (S17).

As a response signal, for example, a session maintenance signal may be used or an ACK signal as an acknowledgment of the session maintenance signal transmitted from the server application processing unit 410 may be used.

For example, in the case of a TCP KEEPALIVE signal, the server application processing unit 410 and the user application processing unit 240 periodically transmit a KEEPALIVE signal (session maintenance signal). In this case, the session management signal generating unit 130 generates a KEEPALIVE signal equal to one transmitted from the user application processing unit 240 and transmits the generated KEEPALIVE signal to the server application processing unit 410. For example, the session management signal generating unit 130 generates a session maintenance signal, for example, by swapping the source and destination addresses of the session maintenance signal transmitted from the server application processing unit 410.

In addition, in the case of an SCTP HEARTBEAT signal, a signal equal to an ACK signal transmitted from the user application processing unit 240 as an acknowledgment of a HEARTBEAT signal transmitted from the server application processing unit 410 may be used as a response signal. For example, the session management signal generating unit 130 generates a packet, for example, by swapping the source and destination addresses of the session maintenance signal transmitted from the server application processing unit 410 and inserting “5” into the type field of the generic chunk header. Thus, the session management signal generating unit 130 may, for example, generate an ACK signal as a response signal.

Thus, the session management signal generating unit 130, for example, as a response signal, generates a session maintenance signal in which the source and destination addresses of a session maintenance signal transmitted from the server application processing unit 410 are swapped with each other. Alternatively, the session management signal generating unit 130, for example, generates an ACK signal as a response signal to the session maintenance signal transmitted from the server application processing unit 410.

On the other hand, the mobile device 200 also generates a response signal as a response to the session maintenance signal output from the user application processing unit 240 (S18).

The session management signal generating unit 230 of the mobile device 200 generates a response signal on the basis of an instruction from the call control unit 245. As a response signal, for example, a session maintenance signal may be used or an ACK signal for acknowledging the session maintenance signal transmitted from the user application processing unit 240 may be used.

For example, the session management signal generating unit 230 generates a session maintenance signal in which the source and destination address of the session maintenance signal transmitted from the user application processing unit 240 are swapped with each other. Alternatively, the session management signal generating unit 230, for example, generates a packet in which the source and destination addresses of a session maintenance signal transmitted from the user application processing unit 240 are swapped with each other and in which “5” is inserted into the type field of the generic chunk header.

Thus, the session management signal generating unit 230, for example, as a response signal, generates a session maintenance signal in which the source and destination addresses of a session maintenance signal transmitted from the user application processing unit 240 are swapped with each other. Alternatively, the session management signal generating unit 230, for example, generates an ACK signal as a response signal to the session maintenance signal transmitted from the user application processing unit 240.

Upon receiving a session maintenance signal from the server application processing unit 410, the session management signal generating unit 130 of the base station 100 does not transmit this signal through the wireless channel but rather transmits a generated response signal to the server application processing unit 410 (S20, S21).

In addition, upon receiving a session maintenance signal from the user application processing unit 240, the session management signal generating unit 230 of the mobile device 200 does not transmit the received signal through the wireless channel but rather transmits the generated response signal to the user application processing unit 240 (S22, S23).

Thus, when the uplink radio quality is improved, the base station 100 and the mobile device 200 operate so as not to transmit a session maintenance signal through the wireless channel. This is because, for example, when the radio quality of the wireless channel between the base station 100 and the mobile device 200 is improved (the connection state of the wireless channel is good), it is expected that there will be a certain level of assurance that data will reach the destination when the base station 100 and the mobile device 200 transmit data though the wireless channel in this state.

Under such conditions, for example, transmission of a session maintenance signal through the wireless channel by the base station 100 and the mobile device 200 in order to confirm whether a session is established would probably result in unnecessary traffic in the wireless channel. In addition, in the wireless channel, for example, a periodic check is made using, for example, a pilot signal in the wireless layer (wireless protocol), and confirmation of session maintenance in the wireless channel is made using two signals.

Consequently, in this embodiment, when the uplink radio quality is improved (connection state of wireless channel is better than that indicated by a threshold), the base station 100 and the mobile device 200 operate so as not to transmit a session maintenance signal, thereby reducing the occurrence of unnecessary traffic. Further, since the base station 100 and the mobile device 200 do not transmit a session maintenance signal, the corresponding amount of wireless resources may be utilized in transmission of other data (for example, service data) and wireless resources may be more effectively utilized. In addition, since the mobile device 200 does not receive a session maintenance signal via the wireless channel, a reduction in power consumption in a reception operation may be achieved.

The session management signal generating units 130 and 230 transmit service data, which is not a session maintenance signal, as is to either the mobile device 200 or base station 100 (S18).

1.2 Case in which Operation is Performed at a Time when Quality of Downlink Wireless Channel is Improved

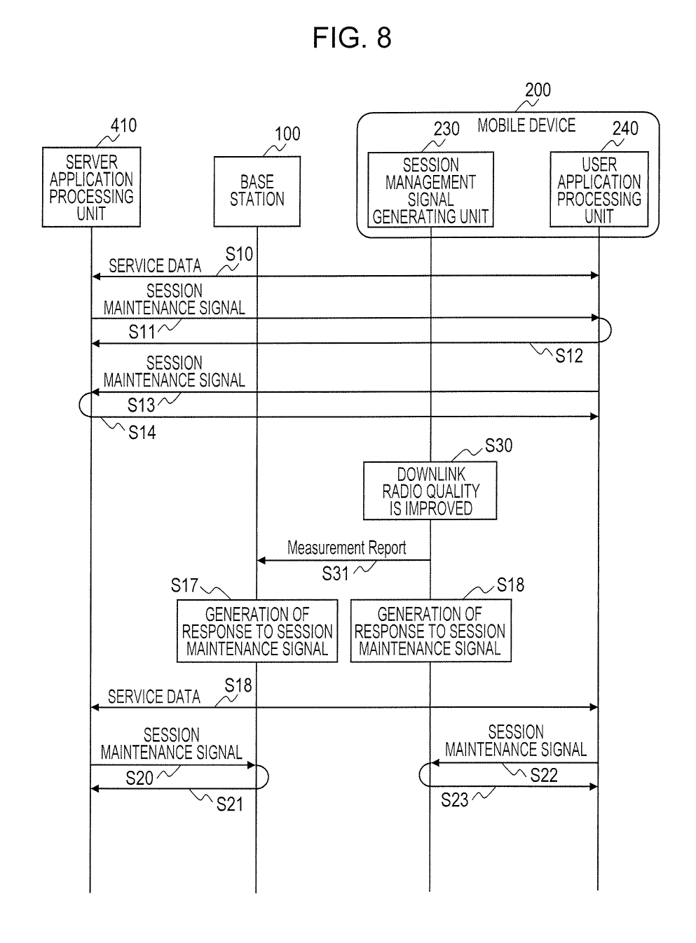

An example of operation was described above from the viewpoint of uplink radio quality. In the case in which operation is performed at a time when downlink radio quality is improved, the operation is performed in substantially the same way as the example of uplink operation. FIG. 8 is a sequence diagram illustrating an example of operation at this case.

In the case of a downlink operation, measurement of downlink radio quality is, for example, performed by the mobile device 200. That is, upon detecting that the downlink radio quality is improved (S30), the mobile device 200 generates a response signal (S18), and notifies the base station 100 of the fact that the downlink radio quality is improved (S31).

For example, when the demodulation and radio quality measurement unit 215 of the mobile device 200 outputs a result of measurement of measured downlink radio quality to the call control unit 245 and the call control unit 245 detects that the downlink radio quality has been continuously equal to or higher than a threshold for a certain period of time, the call control unit 245 determines that the downlink radio quality is improved.

In addition, as a response signal, a signal equal to the session maintenance signal transmitted from the server 400 (for example, a KEEPALIVE signal) may be used, or a signal equal to the ACK signal (this may also be a session maintenance signal) transmitted from the server 400 as a response to the session maintenance signal (for example HEARTBEAT signal) transmitted by the mobile device 200 may be used.

For example, notification of the fact that the downlink radio quality is improved may be made via a measurement report. In the example illustrated in FIG. 8, a measurement report is generated and transmitted by the session management signal generating unit 230, but, for example, notification may be made to the wireless protocol processing unit 220 by the call control unit 245, and the wireless protocol processing unit 220 may generate and transmit the measurement report.

Upon receiving notification of the fact that the downlink radio quality is improved, the base station 100 generates a response signal as a response to the session maintenance signal (S17). The response signal, for example, may be a signal equal to the session maintenance signal transmitted from the mobile device 200 or may be a signal equal to the ACK signal transmitted from the mobile device 200 as a response to the session maintenance signal from the server 400. Hereafter, the operation may be performed in the same way as in “1.1 Case in which operation is performed at a time when quality of uplink wireless channel is improved”.

In the example of the operation, when the downlink radio quality is improved (when it is good), the base station 100 and the mobile device 200 do not transmit a session maintenance signal through the wireless channel and therefore the occurrence of unnecessary traffic may be reduced. In addition, since the base station 100 and the mobile device 200 do not transmit a session maintenance signal, the corresponding amount of wireless resources may be utilized in transmission of other data (for example, service data) and wireless resources may be more effectively utilized. In addition, since the mobile device 200 does not receive a session maintenance signal via the wireless channel, a reduction in power consumption in a reception operation may be achieved.

2. Case in which Connection State of Wireless Channel has Deteriorated

Next, an example of operation in a case where the connection state of the wireless channel has deteriorated will be described. In this example of operation, for example, the connection state of the wireless channel corresponds to the radio quality of the wireless channel.

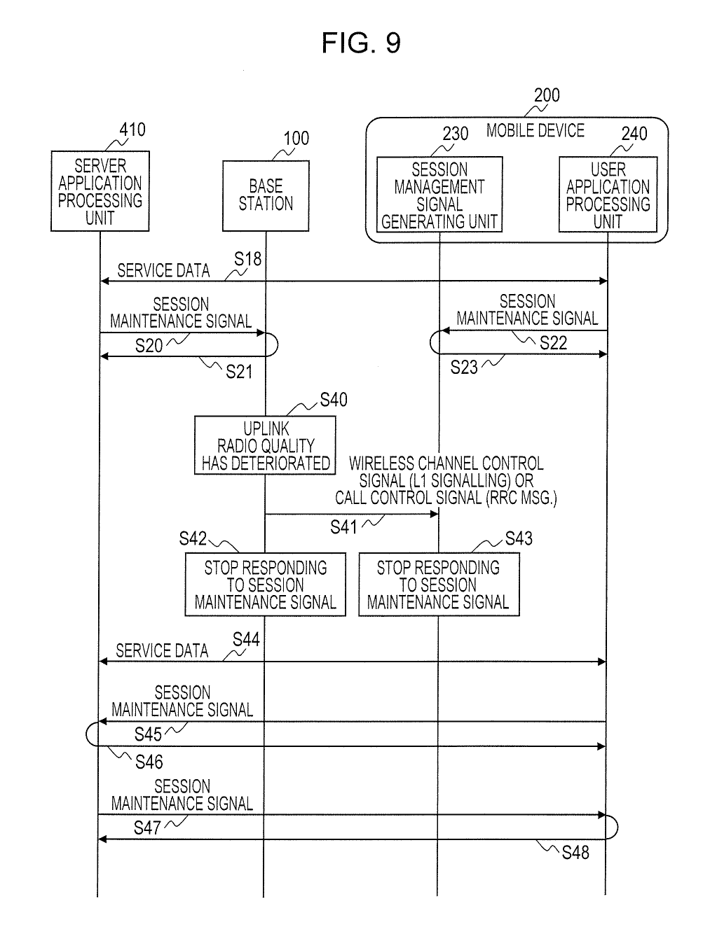

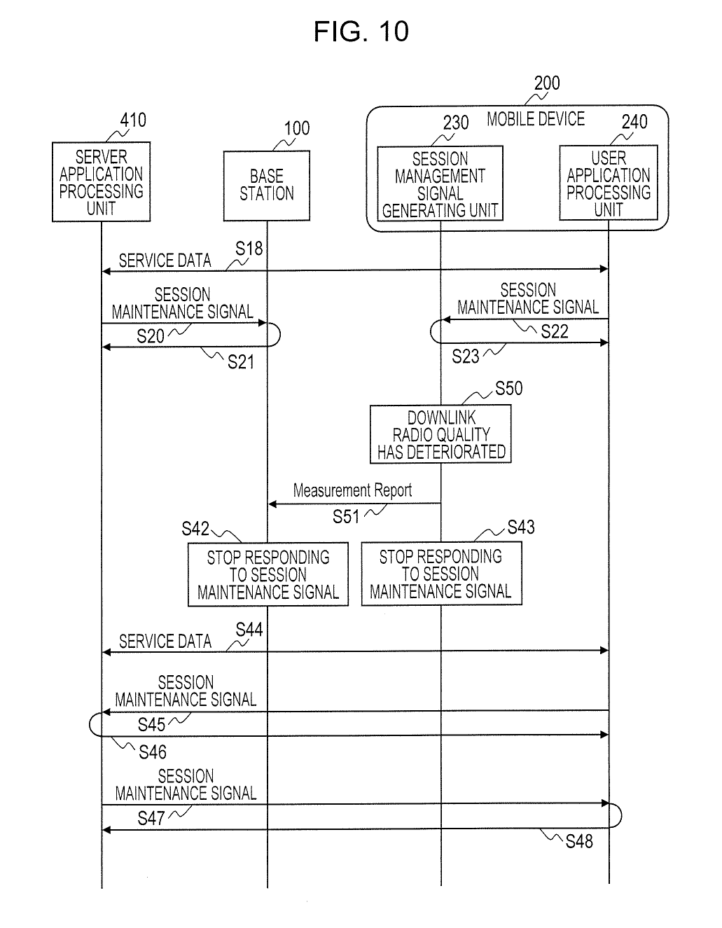

FIG. 9 is a sequence diagram illustrating an example of operation in a case where operation is performed at a time where the quality of an uplink wireless channel has deteriorated (for example, connection state has become worse than that indicated by a threshold) and FIG. 10 is a sequence diagram illustrating an example of operation in a case where operation is performed at a time where the quality of a downlink wireless channel has deteriorated.

Here, in both cases, for ease of description, it is assumed that operation started from a case in which the connection state of the wireless channel is better than a state indicated by a threshold (for example, see FIG. 5 and FIG. 8). In FIG. 9 and FIG. 10, the same symbols denote the same processing as in the above-described examples of operation.

As illustrated in FIG. 9, since the connection state of the wireless channel is better than a state indicated by a threshold (for the uplink wireless channel or downlink wireless channel), session maintenance signals are not transmitted through the wireless channel, and response signals are transmitted to the server application processing unit 410 and the user application processing unit 240 (S20 to S23).

Next, the base station 100 detects deterioration of the uplink radio quality (S40). For example, when the call control unit 145 receives a result of measurement of the uplink radio quality measured by the demodulation and radio quality measurement unit 115 and detects that the uplink radio quality has been continuously lower than or equal to a threshold for a certain period of time, the call control unit 145 determines that the uplink radio quality has deteriorated.

Next, the base station 100 notifies the mobile device 200 of deterioration of the uplink radio quality (S41) and instructs the mobile device 200 to stop generation and transmission of a response signal as a response to the session maintenance signal (S42).

For example, the base station 100 may perform the notification of deterioration of uplink radio quality, using a call control message or a wireless layer control signal, in a manner similar to the above mentioned example.

In addition, for example, the call control unit 145 instructs the session management signal generating unit 130 to stop generation and transmission of a response signal. The session management signal generating unit 130 receives this instruction and stops generation and transmission of a response signal. The session management signal generating unit 130 transmits user data transmitted from the server application processing unit 410 (both of service data and session maintenance signal) to the mobile device 200 (S44 to S48).

On the other hand, the mobile device 200 receives notification of deterioration of the uplink radio quality and instructs stopping of generation and transmission of a response signal as a response to the session maintenance signal (S43).

For example, upon receiving notification of deterioration of the uplink radio quality via the wireless protocol processing unit 220, the call control unit 245 instructs the session management signal generating unit 230 to stop generation and transmission of a response signal. The session management signal generating unit 230 receives this instruction, stops generation and transmission of a response signal, and transmits user data transmitted from the user application processing unit 240 (also service data and session maintenance signal) to the base station 100 (S44 to S48).

FIG. 10 illustrates an example of operation in the case where operation is performed at a time when quality of the downlink wireless channel has deteriorated. When deterioration of downlink radio quality is detected in the mobile device 200 (S50), the session management signal generating unit 230 is instructed to stop generation and transmission of a response signal (S43). In addition, the mobile device 200 notifies the base station 100 of deterioration of the downlink radio quality (S51).

The base station 100 receives notification of deterioration of downlink radio quality and instructs the session management signal generating unit 130 to stop generation and transmission of a response signal (S42).

Upon receiving this stoppage instruction, for example, the session management signal generating unit 130 transmits user data transmitted from the server application processing unit 410 to the mobile device 200 (S44 to S48). In addition, the session management signal generating unit 230 also, for example, transmits user data transmitted from the user application processing unit 240 to the base station 100 (S44 to S48).

Thus, in this example of operation, when downlink radio quality has deteriorated, the base station 100 and the mobile device 200 operate so as to transmit a session maintenance signal through the wireless channel. This is a state in which, for example, it is not possible to guarantee that radio signals of the wireless protocol are able to be transmitted and received. Therefore, in this state, when transmission and reception of a session maintenance signal of a higher level protocol is stopped, sometimes it is not possible to confirm whether a session is established between the server 400 and the mobile device 200. In such a case, the base station 100 and the mobile device 200 operate so as to transmit a session maintenance signal through the wireless channel. In this way, the server 400 and the mobile device 200 may determine, with certainty, whether a session is established or not between the server 400 and the mobile device 200.

3. Case in which Wireless Channel is Disconnected

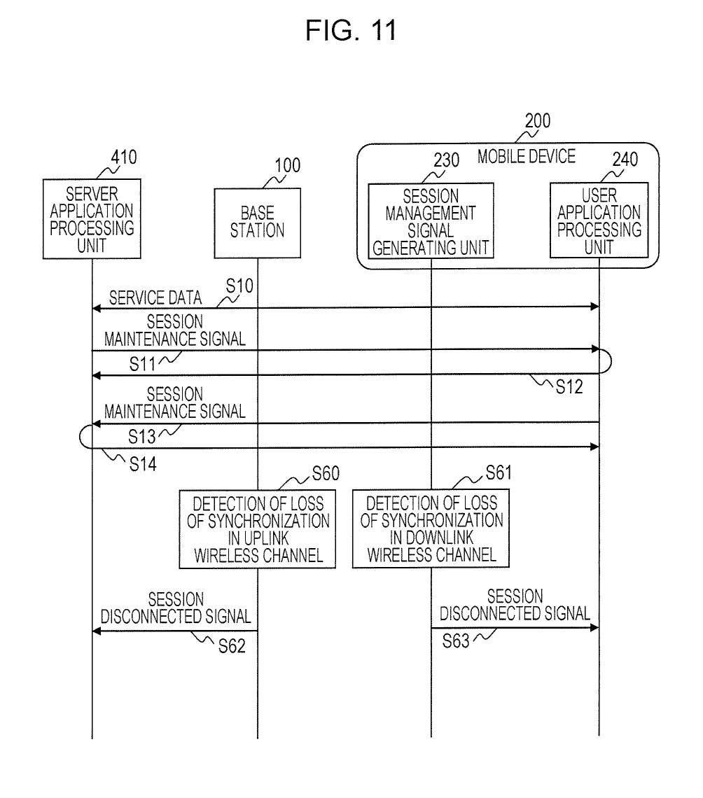

Next, an example of operation in a case where the wireless channel is disconnected will be described. FIG. 11 is a sequence diagram illustrating an example of operation in the case where the wireless channel is disconnected.

The base station 100 and the mobile device 200 transmit and receive user data to and from each other (S10 to S14), and then the base station 100 detects a loss of synchronization in the uplink wireless channel (S60).

For example, when the demodulation and radio quality measurement unit 115 detects that it has become unable to receive an uplink radio signal transmitted from the mobile device 200, the demodulation and radio quality measurement unit 115 notifies the call control unit 145 of disconnection of the wireless channel between the base station 100 and the mobile device 200 due to loss of synchronization. For example, the demodulation and radio quality measurement unit 115 detects that there has been a loss of synchronization when a state in which it is not possible to demodulate and decode received uplink radio signals into a meaningful wireless frame format has continued for a certain period of time.

Upon detecting a loss of synchronization in the uplink wireless channel between the base station 100 and the mobile device 200, the base station 100 transmits a session disconnected signal to the server application processing unit 410 (S62).

For example, the call control unit 145 instructs the session management signal generating unit 130 to generate and transmit a session disconnected signal. The session management signal generating unit 130 receives this instruction, and generates a session disconnected signal and transmits the generated session disconnected signal to the server 400. In this case, the session management signal generating unit 130, for example, generates and transmits the session disconnected signal through a wired channel to the server 400 that handles user data of the mobile device 200.

As an example of a session disconnected signal, a TCP packet in which the “FIN” flag of the TCP header (for example FIG. 6B) is set at ON may be used in the case of the TCP protocol. Alternatively, as an example of a session disconnected signal, an SCTP packet in which “7” (shut down) has been inserted into the type field of the generic chunk header (for example, FIG. 7B) may be used in the case of the SCTP protocol.

Meanwhile, in the mobile device 200, when a loss of synchronization is detected in the downlink wireless channel (S61), a session disconnected signal is transmitted to the user application processing unit 240 (S63).

For example, when the demodulation and radio quality measurement unit 215 detects that it has become unable to receive a downlink radio signal transmitted from the base station 100, the demodulation and radio quality measurement unit 215 notifies the call control unit 245 of disconnection of the wireless channel between the base station 100 and the mobile device 200 due to loss of synchronization. For example, the demodulation and radio quality measurement unit 215 detects that there has been a loss of synchronization when a state in which it has not been possible to demodulate and decode received downlink radio signals into a meaningful wireless frame format has continued for a certain period of time.

Then, the call control unit 245, for example, instructs the session management signal generating unit 230 to generate and transmit a session disconnected signal. The session management signal generating unit 230 receives this instruction, generates a session disconnected signal and transmits the generated session disconnected signal to the user application processing unit 240. As an example of a session disconnected signal, a TCP packet in which the “FIN” flag (for example, FIG. 6B) of the TCP header is set at ON, or a SCTP packet in which “7” has been inserted into the type field of the generic chunk header (for example, FIG. 7B) may be used.

In this example of operation, thus, when a loss of synchronization is detected in the wireless channel between the base station 100 and the mobile device 200, session disconnected signals are transmitted to the server application processing unit 410 and the user application processing unit 240.

Thus, for example, when the base station 100 or mobile device 200 detects interruption of the wireless channel, notification is immediately made using a session disconnected signal in a higher layer protocol than the wireless protocol (for example, TCP protocol). In this case, having received notification via the session disconnected signal, the server 400 or the mobile device 200 is able to quickly stop transmission of user data. Consequently, user data is not transmitted during a time lag from when the wireless channel was interrupted until when the session was disconnected in a higher level layer, thereby allowing the mobile communication system 10 to reduce the occurrence of unnecessary traffic. In addition, for example, since transmission of user data does not take place during this time lag, power consumption of the mobile device 200 may be reduced, and furthermore wireless resources may be used in the transmission of other data, allowing wireless resources to be more effectively utilized.

4. Case in which Connection of Wireless Channel is Restored.

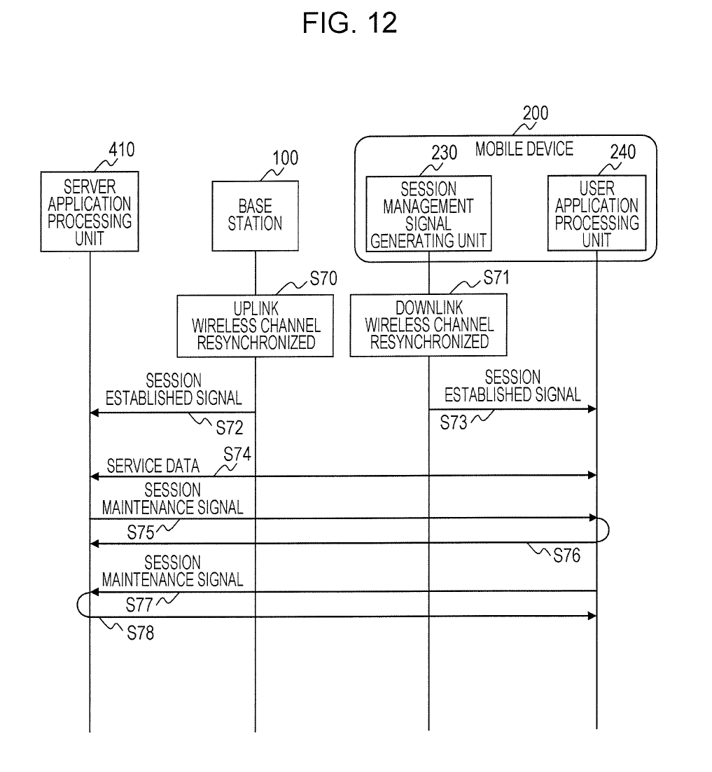

As the next example of operation, an example of operation will be described for a case in which the connection of a wireless channel is restored after the wireless channel had been disconnected. FIG. 12 is a sequence diagram illustrating an example of operation in the case where connection of the wireless channel is restored.

The base station 100 detects re-synchronization of the uplink wireless channel (S70). Regarding re-synchronization, for example, the demodulation and radio quality measurement unit 115 detects that re-synchronization has occurred upon once again being able to receive radio signals transmitted from the mobile device 200 (for example, when a state in which received radio signals have been able to be demodulated and decoded into a meaningful wireless frame format has continued for a certain period of time), and the demodulation and radio quality measurement unit 115 notifies the call control unit 145 of this fact. Upon being notified of this fact, the call control unit 145 instructs the session management signal generating unit 130 to generate and transmit a session established signal.

Then, the base station 100 transmits the session established signal to the server application processing unit 410 (S72). For example, the session management signal generating unit 130 may generate a session established signal on the basis of the instruction from the call control unit 145.

The session established signal, for example, may be a TCP packet in which the “SYN” flag in the TCP header is set at “ON” (for example, FIG. 6B) in the case of the TCP protocol, or an SCTP packet in which the type field in the generic chunk header is set at “1” (initiation).

On the other hand, in the mobile device 200, when re-synchronization of the downlink wireless channel is detected (S71), the user application processing unit 240 is notified of this fact by a session established signal (S73). For example, the demodulation and radio quality measurement unit 215 detects re-synchronization upon once again being able to receive a radio signal transmitted from the base station 100 and then notifies the call control unit 245 of this fact. Upon being notified of this fact, the call control unit 245 instructs the session management signal generating unit 230 to generate and transmit a session established signal. Then, for example, upon receiving this instruction, the session management signal generating unit 230 generates a session established signal to notify the user application processing unit 240 of this fact.

The server 400 and mobile device 200, upon receiving the session established signals, transmit and receive user data to and from each other (S74 to S78).

Thus, in this example of operation, when connection of the wireless channel has been restored, the base station 100 and the mobile device 200 operate so as to transmit a session established signal to each other.

Thus, for example, when the base station 100 and the mobile device 200 detect restoration of the wireless channel, notification of this fact is immediately made using a session established signal in a higher layer protocol than the wireless protocol (for example, TCP protocol).

Thus, notification of reopening of the wireless channel may be immediately made in a high level protocol, and, upon receiving notification of this fact via the session established signal, the server 400 and the mobile device 200 may quickly resume transmission of user data.

### Other Embodiments

In the second embodiment, for example, description was given of an example of a case in which the connection state of a wireless channel is good, but, for example, control may be performed more in accordance with characteristics of a service.

For example, the operation described in the second embodiment may be performed for a service that does not requires a realtime characteristic and in which communication is only intermittently performed (for example, a web browsing service), whereas the operation according to the embodiments is not performed for a service that possesses a realtime characteristic and in which communication is continuously performed (for example, a call service).

This control, for example, may be performed such that the base station 100 is notified of Quality of Service (QoS) information (for example, permitted delay time, bandwidth used by a service, degree of priority of service) by the server 400 and the base station 100 then decides whether or not the operation is to be performed on the basis of the QoS information, and thereafter detects whether the radio quality is improved or deteriorated (S15, S40).

Alternatively, in the case where identification information identifying service application is able to be transmitted and received in a high level protocol, the base station 100 may determine whether or not to perform the operation on the basis of the identification information.

In the second embodiment, an example has been described in which the base station 100 and the mobile device 200 wait to receive a session maintenance signal (for example, S20, S22 in FIG. 5) and then transmit a generated response signal to the server application processing unit 410 and the user application processing unit 240 (for example, FIG. 5 and FIGS. 8 to 10). For example, the base station 100 and the mobile device 200 may instead transmit a generated response signal without waiting to receive a session maintenance signal. For example, the order of S20 and S21 and the order of S22 and S23 in FIGS. 5 and 8 may be reversed.

In addition, in the second embodiment, it has been described that, for example, depending on the connection state of a wireless channel, the base station 100 and the mobile device 200 generate a response signal as a response to a session maintenance signal and then transmit the generated response signal. For example, the base station 100 and the mobile device 200 may instead generate a response signal in advance and store this response signal in a memory or the like. The base station 100 and the mobile device 200 may then read out a corresponding response signal from the memory in accordance with the connection state of the wireless channel and transmit this response signal.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for managing a session established using a wireless channel between a base station and a mobile device in a mobile communication system, a first session maintenance signal being exchanged between a server coupled to the base station and an application processing unit inside the mobile device, via the wireless channel, to confirm that a session is established between the server and the application processing unit, the method comprising:
sending, by the base station, to the server, one of control signals according to a connection state of the wireless channel, without sending the received first session maintenance signal to the mobile device via the wireless channel, the control signals including a second session maintenance signal responsive to the first session maintenance signal, a session disconnected signal indicating disconnection of the session, and a session established signal indicating restoration of the session; and
sending, by the mobile device, to the application processing unit inside the mobile device, one of the control signals according to a connection state of the wireless channel, without sending the received first session maintenance signal to the server via the wireless channel.

2. The method of claim 1, wherein
when the connection state is better than a state indicated by a threshold, the base station and the mobile device send the second session maintenance signal to the server and the application processing unit inside the mobile device, respectively, without sending the first session maintenance signal via the wireless channel.

3. The method of claim 2, wherein
in response to the first session maintenance signal, the base station and the mobile device each send, as the second session maintenance signal, one of a signal obtained by swapping source and destination addresses in the first session maintenance signal and an acknowledge (ACK) signal indicating that the session is being maintained.

4. The method of claim 3, wherein,
in response to a KEEPALIVE signal that is transmitted as the first session maintenance signal, the base station and the mobile device each send, as the second session maintenance signal, a signal obtained by swapping source and destination addresses in the KEEPALIVE signal; or
in response to a HEARTBEAT signal that is transmitted as the first session maintenance signal, the base station and the mobile device each send an acknowledgment (ACK) signal indicating that the session is being maintained.

5. The method of claim 4, wherein
in response to TCP packet data that is transmitted as the first session maintenance signal and a TCP data field of which is empty, the base station and the mobile device each send, as the second session maintenance signal, packet data obtained by swapping source and destination addresses in the TCP packet data; or
in response to SCTP packet data that is transmitted as the first session maintenance signal and in which value 5 is set to a type field of a generic chunk header, the base station and the mobile device each send, as the second session maintenance signal, packet data obtained by swapping source and destination addresses in the SCTP packet data.

6. The method of claim 1, wherein
when the connection state has become worse than a state indicated by a threshold, the base station and the mobile device each send the first session maintenance signal via the wireless channel by stopping sending of the second session maintenance signal.

7. The method of claim 1, wherein
the base station and the mobile device each determine the connection state of the wireless channel, based on radio quality of the wireless channel.

8. The method of claim 7, wherein
the base station and the mobile device transmit a determination result indicating whether the radio quality of the wireless channel is improved or deteriorated, to the mobile device and the base station, respectively; and
the mobile device and the base station determine the connection state, based on the determination results that have been transmitted from the base station and the mobile device, respectively.

9. The method of claim 1, wherein
when the connection state has become a disconnected state, the base station and the mobile device send the session disconnected signal to the server and the application processing unit inside the mobile device, respectively.

10. The method of claim 9, wherein
upon failing to receive a radio signal transmitted from the mobile device or the base station via the wireless channel between the mobile device and the base station, each of the base station and the mobile device determines that the connection state has become a disconnected state.

11. The method of claim 9, wherein
the base station and the mobile device each send, as the session disconnected signal, TCP packet data in which a FIN flag of a TCP header is set at ON or SCTP packet data in which “7” is inserted into a type field of a generic chunk header.

12. The method of claim 1, wherein
when it is determined that the connection state is restored to a connected state from a disconnected state, the base station and the mobile device each send the session established signal.

13. The method of claim 12, wherein
upon once again receiving radio signals transmitted from the mobile device and the base station via the wireless channel, the base station and the mobile device respectively determine that the connection state of the wireless channel is restored from a disconnected state to a connected state.

14. The method of claim 12, wherein
the base station and the mobile device each send, as the session established signal, TCP packet data in which a SYN flag of a TCP header is set at ON or SCTP packet data in which value 1 is inserted into a type field of a generic chunk header.

15. A base station for managing a session established using a wireless channel between the base station and a mobile device in a mobile communication system, a first session maintenance signal being exchanged between a server coupled to the base station and an application processing unit inside the mobile device to confirm that a session is established between the server and the application processing unit, the base station comprising:
a wireless interface unit to wirelessly communicate with the mobile device via the wireless channel; and
a session management signal generating unit configured to send, to the server, one of control signals according to a connection state of the wireless channel, without sending the received first session maintenance signal to the mobile device via the wireless channel, the control signals including a second session maintenance signal responsive to the first session maintenance signal, a session disconnected signal indicating disconnection of the session, and a session established signal indicating restoration of the session.

16. A mobile device for managing a session established using a wireless channel between a base station and the mobile device in a mobile communication system, a first session maintenance signal being exchanged between a server coupled to the base station and an application processing unit inside the mobile device to confirm that a session is established between the server and the application processing unit, the mobile device comprising:
a wireless interface unit to wirelessly communicate with the base station via the wireless channel; and
a session management signal generating unit configured to send, to the application processing unit inside the mobile device, one of control signals according to a connection state of the wireless channel, without sending the received first session maintenance signal to the server via the wireless channel, the control signals including a second session maintenance signal responsive to the first session maintenance signal, a session disconnected signal indicating disconnection of the session, and a session established signal indicating restoration of the session.

17. A system for managing a session established using a wireless channel between a base station and a mobile device in a mobile communication system, a first session maintenance signal being exchanged between a server coupled to the base station and an application processing unit inside the mobile device, via the wireless channel to confirm that a session is established between the server and the application processing unit, the system comprising:
the base station configured to send, to the server, one of control signals according to a connection state of the wireless channel, without sending the received first session maintenance signal to the mobile device via the wireless channel, the control signals including a second session maintenance signal responsive to the first session maintenance signal, a session disconnected signal indicating disconnection of the session, and a session established signal indicating restoration of the session; and
the mobile device configured to send, to the application processing unit inside the mobile device, one of the control signals according to a connection state of the wireless channel, without sending the received first session maintenance signal to the server via the wireless channel.
